(19) United States
(12) Patent Application Publication
(10) Pub. No.: US 2025/0158538 A1
(43) Pub. Date: May 15, 2025

(54) INVERTER AND OUTPUT FILTER SYSTEM FOR PROVIDING SINGLE-PHASE AND THREE-PHASE OUTPUT VOLTAGES

(71) Applicant: ZF FRIEDRICHSHAFEN AG, Friedrichshafen (DE)

(72) Inventors: Zbynek ŠTEPÁN, Starý Plzenec (CZ); Frank SEEMANN, Euerbach (DE); Andre EHRSAM, Bergrheinfeld (DE); Martin MACH, Preštice (CZ); Vladimir DVORAK, Schwandorf (DE); Gabriel SCHERER, Deggenhausertal (DE); Tato Gervais AMANI, Nürnberg (DE); Matthias ENGICHT, Bodman-Ludwigshafen (DE)

(21) Appl. No.: 18/720,013

(22) PCT Filed: Dec. 14, 2022
(86) PCT No.: PCT/EP2022/085938

§ 371 Date: Jun. 14, 2024

(30) Foreign Application Priority Data
Dec. 15, 2021 (DE) 10 2021 214 405.5

(51) Int. Cl. H02M 7/44; B60R 16/033; H02M 1/44

(52) U.S. Cl. CPC H02M 7/44; B60R 16/033; H02M 1/44

(57) ABSTRACT

A inverter device for a vehicle has a three-phase inverter, a filter device, a first supply voltage terminal feeding DC voltage from a vehicle battery, a second supply voltage terminal connecting to the vehicle battery, a first supply terminal supplying first AC voltage, a second supply terminal supplying second AC voltage, and a third supply terminal supplying third AC voltage. The filter device has a first coupling terminal electrically coupling with the first supply terminal and a second coupling terminal electrically coupling with the second supply terminal, a filter output supplying filtered AC voltage, and a neutral conductor output. The filter device has a first phase inductance connected between the first coupling terminal and the filter output, a second phase inductance connected between the second coupling terminal and the neutral conductor output, and a filter capacitance connected between the filter output and the neutral conductor output.

### CROSS REFERENCE TO RELATED APPLICATIONS

This is a U.S. national stage of Application No. PCT/EP2022/085938 filed Dec. 14, 2022. Priority is claimed on German Application No. DE 10 2021 214 405.3 filed Dec. 15, 2021 the content of which is incorporated herein by reference.

### 1. Field of the Invention

The present approach relates to an inverter device for a vehicle and a method for operating an inverter device.

### 2. Description of the Related Art

Some vehicles, for example, utility vehicles, have an auxiliary power take-off that provides supply power from a vehicle battery of the vehicle for an additional electric device.

### SUMMARY OF THE INVENTION

With this in mind, the present approach provides an improved inverter device for a vehicle and a method for operating an improved inverter device. Advantageous configurations will be apparent from the following description.

The advantages which are achievable with the present approach consist in that a more practical auxiliary power take-off having an unbalance-compensating function for a vehicle is provided.

An inverter device for a vehicle has a three-phase inverter and a filter device. The three-phase inverter has a first supply voltage terminal for feeding DC voltage from a vehicle battery, a second supply voltage terminal for connecting to the vehicle battery, a first supply terminal for supplying first AC voltage, a second supply terminal for supplying second AC voltage and a third supply terminal for supplying third AC voltage. The filter device has at least one first coupling terminal for electrically coupling with the first supply terminal and a second coupling terminal for electrically coupling with the second supply terminal, at least one filter output for supplying filtered AC voltage and a neutral conductor output. The filter device further has at least a first phase inductance which is connected between the first coupling terminal and the filter output, and a second phase inductance which is connected between the second coupling terminal and the neutral conductor output, and a filter capacitance which is connected between the filter output and the neutral conductor output.

The first AC voltage can be generated by a pair of switches of the three-phase inverter, which are connected between the first supply voltage terminal and the second supply voltage terminal. In a corresponding manner, the second AC voltage can be generated by a second pair of switches of the three-phase inverter, which are connected between the first supply voltage terminal and second supply voltage terminal, and/or the third AC voltage can be generated by a third pair of switches of the three-phase inverter which are connected between the first supply voltage terminal and second supply voltage terminal. The first AC voltage, second AC voltage and/or third AC voltage can be 400 V/vf, where “vf” stands for “variable frequency”. The filter output can serve to connect an electric device, the neutral conductor output advantageously ensures that an unbalance is compensated during operation of the device.

The filter device can further have a cross-phase inductance which is connected between the first coupling terminal and the neutral conductor output. A voltage profile can be harmonized in this way.

According to one aspect, the neutral conductor output can be coupled with the first supply voltage terminal by a first neutral conductor high-voltage capacitance and/or the neutral conductor output can be coupled with the second supply voltage terminal by a second neutral conductor high-voltage capacitance, in particular the second neutral conductor high voltage capacitance can form a part of the filter capacitance. Such capacitances, e.g., in the form of capacitors, can be used to store electrical charge.

The filter device can further have a first auxiliary phase inductance, which is connected between a first tap point between the first phase inductance and first auxiliary phase inductance and the filter output, and a positive phase capacitance is connected between the first tap point and the first supply voltage terminal, and/or a negative phase capacitance can be connected between the first tap point and the second supply voltage terminal, and, in particular, the negative phase capacitance can form a part of the filter capacitance.

The filter output can be formed to provide an AC voltage of 230 V/50 Hz. Accordingly, a single-phase microgrid can be realized for a 230 V consumer.

According to an aspect, however, the filter device can also have at least one second filter output for supplying second AC voltage and a further phase inductance, which is connected between the second coupling terminal and the second filter output, and/or the filter device can have at least a third coupling terminal for electrically coupling with the third supply terminal, a third filter output for supplying third AC voltage and a third phase inductance which is connected between the third coupling terminal and the third filter output. A symmetrical three-phase filter, for example, can be realized in this way.

The filter device can further have a second auxiliary phase inductance, which is connected between a second tap point between the further phase inductance and second auxiliary phase inductance and the second filter output, and a second positive phase capacitance is connected between the second tap point and the first supply voltage terminal, and/or a second negative phase capacitance can be connected between the second tap point and the second supply voltage terminal.

The filter device can further have a third auxiliary phase inductance, which can be connected between a third tap point between the third phase inductance and third auxiliary phase inductance and the third filter output, and a third positive phase capacitance is connected between the third tap point and the first supply voltage terminal, and/or a third negative phase capacitance can be connected between the third tap point and the second supply voltage terminal.

According to an aspect, the filter device can have a third cross-phase inductance which is connected between the third coupling terminal and the neutral conductor output.

The filter output, the second filter output and/or the third filter output can be formed according to an aspect to provide an AC voltage of 400 V/vf. Accordingly, a high-voltage grid can be realized for a 400 V consumer.

A method for operating one of the inverter devices described above has at least one step for connecting the first supply voltage terminal and the second supply voltage terminal to the vehicle battery in order to provide the filtered AC voltage to at least the filter output.

This method can be implemented, for example, in software or hardware or in a combination of software and hardware, for example, in a control device.

A further aspect of the invention is a vehicle which has a vehicle battery and an inverter device according to the invention.

In particular, the vehicle is a utility vehicle which has, at least at times, an auxiliary power take-off that is connected to the filter output. The auxiliary power take-off preferably comprises a work function in which attachments to the vehicle are moved or tempered, such as with crane attachments, dump truck attachments, mixing attachments or refrigeration attachments or in agricultural equipment.

### BRIEF DESCRIPTION OF THE DRAWINGS

Examples of the approach presented herein are shown in the drawings and explained in more detail in the following description. The drawings show:

FIG. 1 is a schematic depiction of an inverter device according to an embodiment example;

FIG. 2 is a schematic depiction of an inverter device according to an embodiment example; and

FIG. 3 is a flow diagram of a method according to an embodiment example for operating an inverter device.

### DETAILED DESCRIPTION OF THE PRESENTLY PREFERRED EMBODIMENTS

In the following description of preferred examples of the present invention, like or similar reference numerals are used for the similarly operating elements shown in the various figures to avoid repetitive description of these elements.

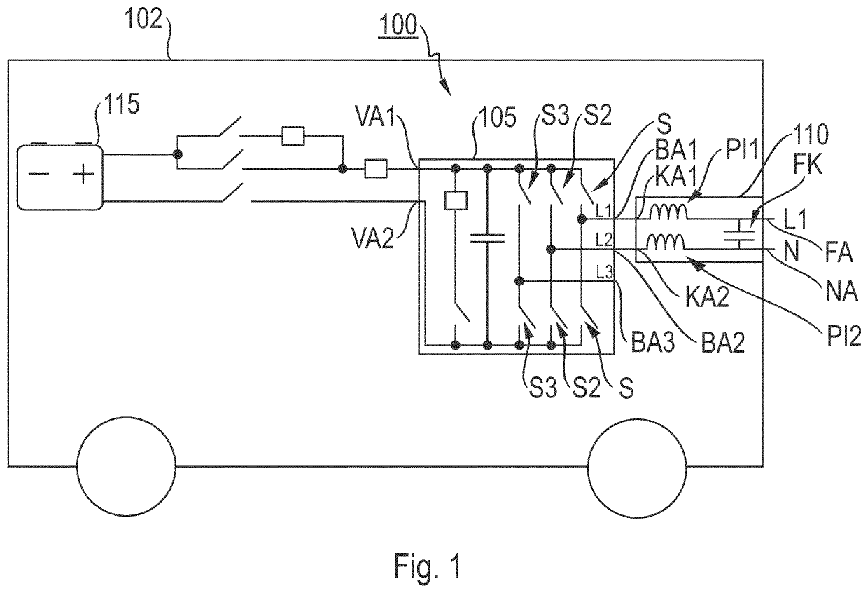

FIG. 1 shows a schematic depiction of an inverter device 100 according to an aspect of the invention. The inverter device 100 is suitable for use in a vehicle 102.

The inverter device 100 has a three-phase inverter 105 and a filter device 110. The three-phase inverter 105 has a first supply voltage terminal VA1 for feeding DC voltage from a vehicle battery 115, a second supply voltage terminal VA2 for connecting to the vehicle battery 115, a first supply terminal BA1 for supplying first AC voltage, a second supply terminal BA2 for supplying second AC voltage, and a third supply terminal BA3 for supplying third AC voltage. The filter device 110 has at least one first coupling terminal KA1 for electrically coupling with the first supply terminal BA1 and a second coupling terminal KA2 for electrically coupling with the second supply terminal BA2, at least one filter output FA for supplying filtered AC voltage and a neutral conductor output NA. The filter device 110 further has at least one first phase inductance PI1 which is connected between the first coupling terminal KA1 and the filter output FA, and a second phase inductance PI2 which is connected between the second coupling terminal KA2 and the neutral conductor output NA, and a filter capacitance FK which is connected between the filter output FA and the neutral conductor output NA.

According to this example, the first AC voltage is generated by a pair of switches S of the three-phase inverter 105 connected between the first supply voltage terminal VA1 and second supply voltage terminal VA2. In a corresponding manner, the second AC voltage according to example is generated by a second pair of switches S2 of the three-phase inverter 105 connected between the first supply voltage terminal VA1 and second supply voltage terminal VA2, and/or the third AC voltage is generated by a third pair of switches S3 of the three-phase inverter 105, which are connected between the first supply voltage terminal VA1 and second supply voltage terminal VA2. The first AC voltage, second AC voltage and/or third AC voltage are 400 V/vf according to this example. The filter output FA according to this example is formed to provide an AC voltage of 230 V/50 Hz.

According to this example, the inverter device 100 realizes a 230 V/50 Hz output and an isolated neutral conductor output NA. With the inverter device 100 disclosed herein, using the three-phase inverter 105 which can also be referred to as “AC/DC inverter” or “E-mobility inverter” and different terminals and filters 110 at its output in the form of supply terminals BA1, BA2, BA3, various functions are obtained. Thanks to the neutral conductor N, which leads into the neutral conductor output NA and which may also be referred to as a “floating neutral”, an unbalance caused by the charge and/or consumer in the 230 V AC current microgrid is advantageously compensated.

Unlike utilization for traction, for example, a three-phase inverter 105 in the inverter device 100 presented here is used for controlling an electric motor of an auxiliary power take-off in order to build up a 230 V/50 Hz microgrid and a floating neutral, in this instance at the neutral conductor output NA.

According to this embodiment example, a 230 VAC/50 Hz microgrid is provided with the following features:
AC voltage: 1×0.230 V±15%
with frequency: 50 Hz ±10% or 60 Hz±10%

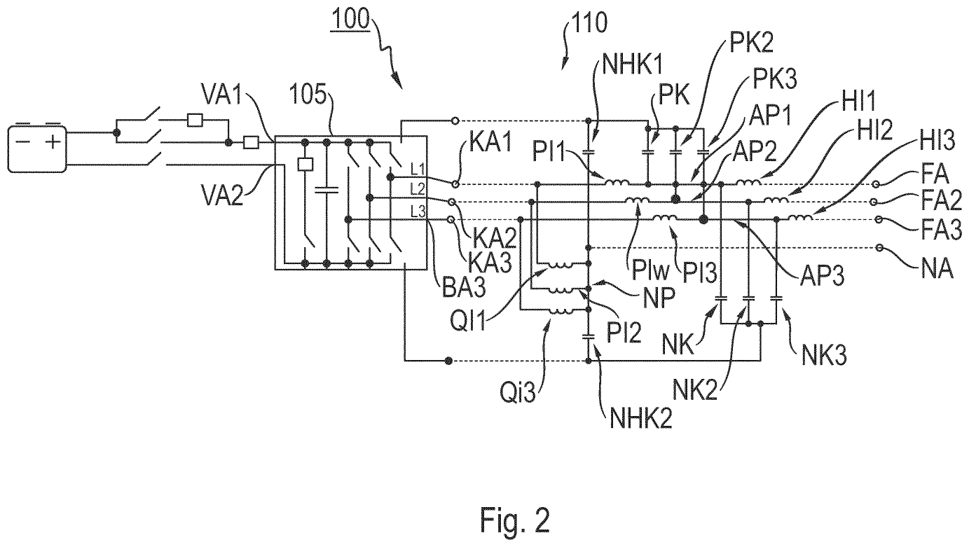

The inverter device 100 comprises the AC/DC inverter 105 with DC input and AC output which comprises three wires. Further, using the inverter device 100, different functions, for example, three functions, of an inverter 105 are made possible through various terminals and filter 110 at its output:
1st Function: According to this embodiment example, the three-phase inverter 105 comprises the filter device 110 at the output in order to obtain 230 V/50 Hz, 10 A or 16 A, and to build up a single-phase microgrid.
2nd Function: According to an alternative embodiment example, the three-phase inverter provides a three-phase electric motor as drive with variable frequency, for example, 400 V/vf.
3rd Function: According to an embodiment example shown in FIG. 2, a symmetrical filter generates a neutral point between a positive high-voltage path HV+ and a negative high-voltage path HV− for the three-phase system. The neutral point makes it possible for the system to handle an asymmetrical system on the average for light loads, for example, a 230 V application.

The inverter device 100 offers a low-cost solution for a supply grid.

FIG. 2 shows a schematic diagram of an inverter device 100 according to an aspect of the invention. The difference between this inverter device 100 and the inverter device 100 described in FIG. 1 consists in that the inverter device 100 according to this example realizes the third function described in FIG. 1 in which the filter device 110 in the form of a symmetrical filter generates the neutral point NP between the positive high-voltage path HV+ and the negative high-voltage path HV−.

The filter device 110 according to this example further has a cross-phase inductance QI1 which is connected between the first coupling terminal KA1 and the neutral conductor output NA. According to this example, the neutral conductor output NA is further coupled with the first supply voltage terminal VA1 by a first neutral conductor high-voltage capacitance NHK1 and/or the neutral conductor output NA is coupled with the second supply voltage terminal VA2 by a second neutral conductor high-voltage capacitance NHK2. According to this example, the second neutral conductor high-voltage capacitance NHK2 forms a part of the filter capacitance. According to this example, the filter device 110 further has a first auxiliary phase inductance HI1, which is connected between a first tap point AP1 between the first phase inductance PI1 and first auxiliary phase inductance HI1 and the filter output FA, wherein a positive phase capacitance PK is connected between the first tap point AP1 and the first supply voltage terminal VA1, and/or wherein a negative phase capacitance NK is connected between the first tap point AP1 and the second supply voltage terminal VA2. According to this example, the negative phase capacitance NK forms a part of the filter capacitance. According to this example, the filter device 110 further has at least one second filter output FA2 for supplying second AC voltage and a further phase inductance PIw which is connected between the second coupling terminal KA2 and the second filter output FA2. Further, the filter device 110 according to this example has at least a third coupling terminal KA3 for electrically coupling with the third supply terminal BA3, a third filter output FA3 for supplying third AC voltage and a third phase inductance PI3 which is connected between the third coupling terminal KA3 and the third filter output FA3.

According to this example, the filter device 110 further has a second auxiliary phase inductance HI2 that is connected between a second tap point AP2 between the further phase inductance PIw and second auxiliary phase inductance HI2 and the second filter output FA2, and a second positive phase capacitance PK2 is connected between the second tap point AP2 and the first supply voltage terminal VA1, and/or a second negative phase capacitance NK2 is connected between the second tap point AP2 and the second supply voltage terminal VA2. According to an example, the second negative phase capacitance NK2 forms a part of the filter capacitance. According to this example, the filter device 110 further comprises a third auxiliary phase inductance HI3 which is connected between a third tap point AP3 between the third phase inductance PI3 and third auxiliary phase inductance HI3 and the third filter output FA3, and a third positive phase capacitance PK3 is connected between the third tap point AP3 and the first supply voltage terminal VA1, and/or a third negative phase capacitance NK3 is connected between the third tap point AP3 and the second supply voltage terminal VA2. According to this example, the filter device 110 has a third cross-phase inductance QI3 which is connected between the third coupling terminal KA3 and the neutral conductor output NA. The filter output FA, the second filter output FA2 and/or the third filter output FA3 are formed according to this embodiment example to provide an AC voltage of 400 V/vf±15%. The inverter device 100 according to this example realizes at least a 400 V/vf output and isolated neutral conductor which can also be referred to as “floating neutral” FN.

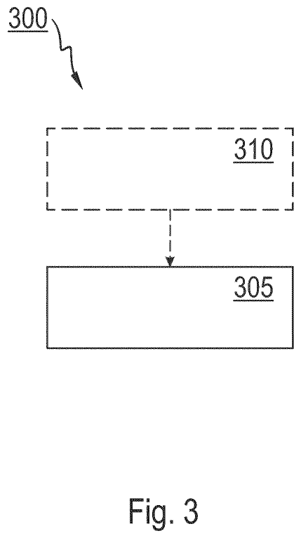

FIG. 3 shows a flow diagram of a method 300 according to an example for operating an inverter device. This inverter device can be the inverter device described in FIG. 1 or 2.

The method 300 has at least one connection step 305 in which the first supply voltage terminal and the second supply voltage terminal are connected to the vehicle battery in order to provide the filtered AC voltage to at least the filter output.

According to this example, method 300 further optionally comprises a supply step 310 before the connection step 305, in which supply step 310 the inverter device and the vehicle battery are supplied.

The examples described above and shown in the figures are selected only as examples. Different embodiment examples in their entirety, or only some features thereof, may be combined with one another. An example can also be modified by features of another example.

When an embodiment example includes an “and/or” conjunction between a first feature and a second feature, this can be interpreted to mean that the embodiment example according to one embodiment form has both the first feature and the second feature and, according to a further embodiment form, either has only the first feature or has only the second feature.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. An inverter device for a vehicle, comprising:
a three-phase inverter with:
a first supply voltage terminal configured to feed DC voltage from a vehicle battery,
a second supply voltage terminal configured to connect to the vehicle battery,
a first supply terminal configured to supply first AC voltage,
a second supply terminal configured to supply second AC voltage, and
a third supply terminal configured to supply third AC voltage; and
a filter device with:
at least one first coupling terminal configured to electrically couple with the first supply terminal,
a second coupling terminal configured to electrically couple with the second supply terminal,
at least one filter output configured to supply filtered AC voltage,
a neutral conductor output,
a first phase inductance which is connected between the at least one first coupling terminal and the at least one filter output,
a second phase inductance which is connected between the second coupling terminal and the neutral conductor output, and
a filter capacitance which is connected between the at least one filter output and the neutral conductor output.

15. The inverter device according to claim 14, wherein the filter device has a cross-phase inductance which is connected between the at least one first coupling terminal and the neutral conductor output.

16. The inverter device according to claim 14,
wherein the neutral conductor output is coupled with the first supply voltage terminal by a first neutral conductor high-voltage capacitance, and/or
wherein the neutral conductor output is coupled with the second supply voltage terminal by a second neutral conductor high-voltage capacitance, and/or
wherein the second neutral conductor high-voltage capacitance forms a part of the filter capacitance.

17. The inverter device according to claim 16, wherein the filter device has:
a first auxiliary phase inductance connected between the at least one filter output and a first tap point that is between the first phase inductance and the first auxiliary phase inductance,
wherein a positive phase capacitance is connected between the first tap point and the first supply voltage terminal, and/or
wherein a negative phase capacitance is connected between the first tap point and the second supply voltage terminal, wherein the negative phase capacitance forms a part of the filter capacitance.

18. The inverter device according to claim 14, wherein the at least one filter output is configured to provide an AC voltage of 230 V/50 Hz.

19. The inverter device according to claim 14,
wherein the filter device has at least one second filter output for supplying second AC voltage,
wherein the filter device has a further phase inductance which is connected between the second coupling terminal and the at least one second filter output, and/or
wherein the filter device has at least a third coupling terminal for electrically coupling with the third supply terminal, a third filter output for supplying third AC voltage, and a third phase inductance which is connected between the third coupling terminal and the third filter output.

20. The inverter device according to claim 19, wherein the filter device further has:
a second auxiliary phase inductance which is connected between a second tap point that is between the further phase inductance and the second auxiliary phase inductance and the at least one second filter output,
wherein a second positive phase capacitance is connected between the second tap point and the first supply voltage terminal, and/or
wherein a second negative phase capacitance is connected between the second tap point and the second supply voltage terminal.

21. The inverter device according to claim 20,
wherein the filter device has a third auxiliary phase inductance which can be connected between a third tap point between the third phase inductance and third auxiliary phase inductance and the third filter output,
wherein a third positive phase capacitance is connected between the third tap point and the first supply voltage terminal, and/or
wherein a third negative phase capacitance is connected between the third tap point and the second supply voltage terminal.

22. The inverter device according to claim 21, wherein the filter device has a third cross-phase inductance which is connected between the third coupling terminal and the neutral conductor output.

23. The inverter device according to claim 22, wherein the at least one filter output, the at least one second filter output and/or the third filter output are/is formed to provide an AC voltage of 400 V/vf.

24. A method for operating an inverter device for a vehicle, having:
a three-phase inverter with:
a first supply voltage terminal configured to feed DC voltage from a vehicle battery,
a second supply voltage terminal configured to connect to the vehicle battery,
a first supply terminal configured to supply first AC voltage,
a second supply terminal configured to supply second AC voltage, and
a third supply terminal configured to supply third AC voltage; and
a filter device with:
at least one first coupling terminal configured to electrically couple with the first supply terminal,
a second coupling terminal configured to electrically couple with the second supply terminal,
at least one filter output configured to supply filtered AC voltage,
a neutral conductor output,
a first phase inductance which is connected between the at least one first coupling terminal and the at least one filter output,
a second phase inductance which is connected between the second coupling terminal and the neutral conductor output, and
a filter capacitance which is connected between the at least one filter output and the neutral conductor output, the method comprising:
at least one step for connecting the first supply voltage terminal and the second supply voltage terminal to the vehicle battery and
providing the filtered AC voltage to at least the at least one filter output.

25. A vehicle comprising:
a vehicle battery; and
an inverter device, comprising:
a three-phase inverter with:
a first supply voltage terminal configured to feed DC voltage from a vehicle battery,
a second supply voltage terminal configured to connect to the vehicle battery,
a first supply terminal configured to supply first AC voltage,
a second supply terminal configured to supply second AC voltage, and
a third supply terminal configured to supply third AC voltage; and
a filter device with:
at least one first coupling terminal configured to electrically couple with the first supply terminal,
a second coupling terminal configured to electrically couple with the second supply terminal,
at least one filter output configured to supply filtered AC voltage,
a neutral conductor output,
a first phase inductance which is connected between the at least one first coupling terminal and the at least one filter output,
a second phase inductance which is connected between the second coupling terminal and the neutral conductor output, and
a filter capacitance which is connected between the at least one filter output and the neutral conductor output.

26. The vehicle according to claim 25, wherein it has, at least at times, an auxiliary power take-off, and the auxiliary power take-off is connected to the at least one filter output
